(19) United States
(12) Patent Application Publication
(10) Pub. No.: US 2014/0216108 A1
(43) Pub. Date: Aug. 7, 2014

(54) METHOD FOR CUTTING THIN GLASS WITH SPECIAL EDGE FORMATION

(71) Applicant: SCHOTT AG, Mainz (DE)

(72) Inventors: Thomas Wiegel, Alfeld (DE); Jürgen Vogt, Oberheimbach (DE); Andreas Habeck, Undenheim (DE); Georg Sparschuh, Alfeld (DE); Holger Wegener, Alfeld (DE); Gregor Kübart, Dresden (DE); Angelika Ullmann, Coppenbrugge (DE)

(73) Assignee: SCHOTT AG, Mainz (DE)

(21) Appl. No.: 14/246,708

(22) Filed: Apr. 7, 2014

Related U.S. Application Data
(63) Continuation of application No. PCT/EP2012/004172, filed on Oct. 5, 2012.

(30) Foreign Application Priority Data
Oct. 7, 2011 (DE) 10 2011 084 128.8

(51) Int. Cl. C03B 29/16; C03B 33/08

(52) U.S. Cl. CPC C03B 29/16; C03B 33/082
USPC 65/56; 65/112; 65/97

(57) ABSTRACT

A method for separating a thin glass sheet, such as a glass film along a predefined cutting line provides the cutting line immediately has a temperature of greater than 250 K below the transformation point Tg of the glass of the thin sheet of glass, including the input of energy along the cutting line using a laser beam which acts such that a separation of the thin glass sheet occurs.

### CROSS REFERENCE TO RELATED APPLICATIONS

This is a continuation of PCT Application No. PCT/EP2012/004172, entitled “METHOD FOR CUTTING THIN GLASS WITH SPECIAL EDGE FORMATION”, filed Oct. 5, 2012, which is incorporated herein by reference.

### BACKGROUND OF THE INVENTION

1. Field of the Invention

The present invention relates to a laser based method for separating a thin glass sheet, in particular a glass film, whereby following separation the glass film displays a specially formed cut edge having a very smooth surface which is free of micro-cracks.

2. Description of the Related Art

For greatly diverse applications, such as for example in the field of consumer electronics, for example as glass covers for organic light-emitting diode (OLED) light sources or for thin or curved display devices, or in the field or regenerative energies or energy technology, such as solar cells, thin glass is increasingly used. Examples for this are touch panels, capacitors, thin film batteries, flexible circuit boards, flexible OLEDs, flexible photo-voltaic modules or also e-papers. Thin glass is moving into focus more and more for many applications due to its excellent characteristics such as resistance to chemicals, temperature changes and heat, gas tightness, high electric insulation properties, customized coefficient of expansion, flexibility, high optical quality and light transparency and also high surface quality with very low roughness due to a fire-polished surface of the two thin glass entities. Thin glass is herein to be understood to be glass films having thicknesses of less than approximately 1.2 millimeters (mm). Due to its flexibility, thin glass in the embodiment of a glass film, especially in the thickness range of less than 250 micrometers (μm) is increasingly wound after production and stored as a glass roll, or transported for cutting to size and further processing. After an intermediate treatment, for example coating or cutting to size the glass film can again be wound in a roll-to roll process and supplied to an additional application. Compared to storing and transporting flat material, winding of the glass includes the advantage of a more cost effective compact storage, transport and handling during further processing.

During further processing smaller glass film segments are separated from the glass roll or also from the material which is stored flat according to the requirements. In some applications these glass film segments are also again utilized as curved or wound glass.

With all of the excellent characteristics glass as a brittle material typically possesses, it generally has a low breaking resistance since it is less resistant against tension. When bending, the glass stresses occur on the outer surface of the bent glass. For breakage-free storing and breakage-free transport of such a glass roll or for crack-free and breakage-free utilization of smaller glass film segments the quality and integrity of the edges are of importance in the first instance, in order to avoid a crack or breakage in the wound or curved glass roll. Even damage to the edges such as minute cracks, for example micro-cracks, can become the cause and the point of origin for larger cracks or breakages in the glass film. Moreover, because of the tension on the top side of the wound or curved glass film, integrity and freedom of the surface from scratches, grooves and other surface defects is important in order to avoid the development of a crack or break in the wound or curved glass film. Thirdly, manufacture related interior stresses in the glass should be as small as possible or nonexistent in order to avoid development of a crack or break in the wound or curved glass film. In particular, the quality of the glass film edge is of importance in regard to crack formation or crack propagation into a break of the glass film.

According to the current state of the art, thin glasses or glass films are mechanically scored and broken with a specially ground diamond or a small wheel of special steel or tungsten carbide. Scoring the surface produces a targeted stress in the glass. Along the thus produced fissure the glass is broken, controlled by pressure, tension or bending.

This causes edges having severe roughness, many micro-cracks and popping and conchoidal ruptures at the edges.

In order to increase edge strength, these edges are subsequently usually edged, beveled or polished. Mechanical edge processing is no longer realizable for glass films, in particular at thicknesses less than 250 μm without causing additional cracking or breakage risks for the glass.

In order to achieve better edge quality the laser scribing process according to the current state of the art is applied in order to break a glass substrate by means of a thermally generated mechanical tension. A combination of both methods is also known and used in the current state of the art. In the laser scribing method, the glass is heated along a precisely defined line with a bundled laser beam, usually a CO₂ laser beam and a thermal tension is produced in the glass by an immediately following cold jet of cooling fluid such as compressed air or an air-fluid mixture that is great enough that the glass is breakable or breaks along the predefined edge. A laser scribing method of this type is described for example in International Patent Publication Nos. DE 693 04 194 T2 and EP 0 872 303 B1 and U.S. Pat. No. 6,407,360. However, this method also produces a broken edge with corresponding roughness and micro-cracks. Originating from the indentations and micro-cracks in the edge, structure tears can form and spread in the glass in particular when bending or winding a thin glass film in a thickness range of less than 250 μm, which eventually lead to a break in the glass.

Various methods suggest a coating of the edge with a synthetic material in order to increase edge strength. A suggestion is made in International Publication No. WO 99/46212 for coating a glass sheet edge with a highly viscous curable synthetic material. The coating can be applied by dipping of the glass edge into the synthetic material and curing with ultra-violet (UV) light.

Protruding synthetic material on the outside surface of the glass sheet is subsequently removed. This method is suggested for glass sheets of 0.1 to 2 mm thickness. Herein it is disadvantageous that it includes several expensive additional process steps and that it is rather unsuitable for glass films in the range of 5 to 250 μm. In particular, on such thin glass films, protruding synthetic material cannot be removed without damaging the film. Moreover, coating of the glass edge and even filling of the micro-cracks as disclosed in International Publication No. WO 99/46212 prevents crack formation and spreading of cracks only to a limited extent. A highly viscous synthetic material as is suggested therein can only cover micro-cracks in the surface structure of the glass sheet edge superficially due to its viscosity. With accordingly acting tension micro-cracks can therefore still act as point of origin for spreading of cracks which then leads to breaking of the glass sheet.

To increase the edge strength of glass substrates in the thickness range of greater than 0.6 mm, or respectively greater than 0.1 mm, International Publication No. WO 2010/135614 suggests surface coating of the edges with a polymer. However, here too such a coating prevents formation and spreading of cracks originating from the edge only to a limited extend as is explained in the document, since micro-cracks in the edge surface structure can lead unhindered from its depth to crack growth. Moreover, a coating process of this type of an edge with synthetic material on thin glass films in the range of 5 to 250 μm can only be implemented at great expense. Moreover it cannot be avoided, in particular with very thin films, that the coating at the edge forms thickenings which cannot be removed without the risk of damaging the film and which represent a great impairment during use or during winding of the glass film.

A complete separation of such a glass film would therefore be desirable whereby a fire-polished smooth edge which is free of micro-cracks is created. If a laser is used for this purpose with the advantage of a temperature increase within a very small local region then there is the problem that the laser beam energy, besides a part which is reflected, is absorbed to the greatest extent by the glass, but is released however as heat only in a very thin surface layer whose thickness corresponds with one wave length.

International Patent No. DE 35 46 001 describes a separation process with laser for a rotationally symmetric hollow glass body which, while rotating, is heated at the cutting location with a gas burner to below the softening point of the glass. Subsequently the cutting location is radiated with the laser, so that a thermal stress or temperature increase is gradually built up along the laser beam due to repeated rotation of the glass. The part which is to be separated is then removed with the assistance of an acting tensile force. However, no solution for cutting a thin glass film is indicated.

International Patent No. DE 196 16 327 describes a method and an apparatus to sever glass tubes having a wall thickness of up to 0.5 mm, wherein the glass tube is heated to a temperature higher than the glass transformation temperature Tg in order to be able to subsequently separate the glass tube by means of a laser with high quality reproducible ends. International Patent No. DE 196 16 327 does not describe severing of thin glass sheets or thin glass ribbons. The glass tubes described in International Patent No. DE 196 16 327 were moreover always reworked, that is the glass tubes were initially cooled and were then heated, for example by a defocused laser beam, immediately before the laser cutting beam and were cut by the laser cutting beam. Separation, for example within the scope of a continuous production process, is not described in International Patent No. DE 196 16 327. The wall thickness of the glass tubes which are to be separated are in the range of 0.1 mm. An inside or outside bead of 25 μm on the glass tubes which are to be separated is tolerated in the method known from International Patent No. DE 196 16 327. Such unevenness introduced by the cutting process is not acceptable for cutting of thin glass sheets, since otherwise excessive tensions occur when bending, leading to breaking of the thin glass sheet, so that the method according to International Patent No. DE 196 16 327 cannot be used for thin glass sheets.

From International Patent No. JP 60 25 11 38, laser cutting with CO₂ lasers has become known, especially also for conventional sheets of glass having thicknesses greater than 0.1 mm. However, no temperatures are specified at which cutting occurs—only that the glass sheet is preheated to a certain temperature. International Patent No. JP 60 25 11 38 can therefore not provide any indication that a laser separation method without bead formation on the surface can also be used for thin sheets of glass instead of conventional sheets.

From International Patent Application Publication DE 10 2009 008 292, a glass layer has become known which was produced in the down-draw or overflow-downdraw-fusion method and which has a maximum thickness of 50 μm and which finds use in capacitors as insulators. From International Patent Application Publication No. DE 10 2009 008 292 it is known to cut the glass layer into individual ribbons by means of a laser. However, no temperatures are specified in regard to laser cutting. Also, no information is given in regard to the bead formation on the edges.

What is needed in the art is to avoid the disadvantages of the current state of the art and to provide a method which permits complete severing of a thin glass, in particular a glass film and which therein provides a cut edge quality of the thin glass which permits bending or rolling of the thin glass, wherein the formation of a crack originating from the cut edge can be avoided to a great extent or completely. In particular, bead formation should also be avoided as much as possible.

### SUMMARY OF THE INVENTION

The present invention provides a method for separating a thin glass sheet, in particular a glass film along a predefined cutting line, wherein the cutting line immediately prior to separating in a first embodiment has an operating temperature of greater than 250 K (Kelvin) below the transformation point Tg of the glass of the thin sheet of glass, for example greater than 100 K below Tg. In another embodiment the operating temperature is in a range of 50 K above and below Tg, for example in a range of 30 K above and below Tg, including the input of energy along the cutting line using a laser beam which acts such that a separation of the thin glass sheet occurs.

This method is suitable for a thin glass in the form of a glass film having a thickness of a maximum of approximately 250 μm, for example a maximum of 120 μm, a maximum of 55 μm, or a maximum of 35 μm and for a glass film having a thickness of at least 5 μm, for example at least 10 μm, or at least 15 μm.

Glass film is to be understood to be a thin glass in a thickness range of 5 to 250 μm. The inventive method can however also be used for thin glasses in a thickness range to 1.2 mm.

This method is moreover suitable for a thin glass sheet, for example in the embodiment of a glass film having an alkaline oxide content of a maximum of 2 weight-%, for example a maximum of 1 weight-%, a maximum of 0.5 weight-%, a maximum of 0.05 weight-%, or a maximum of 0.03 weight-%.

This method moreover is suitable for a thin glass sheet, for example in the embodiment of a glass film from a glass which contains the following components (in weight-% on an oxide basis):

| | |
|---|---|
| SiO₂ | 40-75; |
| Al₂O₃ | 1-25; |
| B₂O₃ | 0-16; |
| Alkaline earth oxide | 0-30; and |
| Alkaline oxide | 0-2. |

This method is moreover suitable for a thin glass sheet, for example in the embodiment of a glass film consisting of a glass that includes the following components (in weight-% on an oxide basis):

| | |
|---|---|
| SiO₂ | 45-70; |
| Al₂O₃ | 5-25; |
| B₂O₃ | 1-16; |
| Alkaline earth oxide | 1-30; and |
| Alkaline oxide | 0-1. |

In one embodiment of the method, such a thin glass, in particular in the embodiment of a glass film is produced from a molten glass, for example glass having low alkaline content in the down-draw method or in the overflow-downdraw-fusion method. It has been shown that both methods which are generally known in the current state of the art (compare for example International Publication No. WO 02/051757 A2 for the down-draw-method and International Publication No. WO 03/051783 A1 for the overflow-downdraw-fusion method) are suitable for drawing thin glass films having a thickness of less than 250 μm, for example less than 120 μm, less than 55 μm, or less than 35 μm and having a thickness of at least 5 μm, for example at least 10 μm, or at least 15 μm.

In the down-draw-method which is described in principle in International Publication No. WO 02/051757 A2, bubble-free and well homogenized glass flows into a glass reservoir, the so-called drawing tank. The drawing tank consists of precious metals, for example platinum or platinum alloys. Arranged below the drawing tank is a nozzle device, having a slotted nozzle. The size and shape of this slotted nozzle defines the flow of the drawn glass film, as well as the thickness distribution across the width of the glass film. The glass film is drawn downward by use of draw rollers at a speed, depending on the glass thickness, of 2 to 110 meters per minute (m/min) and eventually arrives in an annealing furnace which is located following the draw rollers. The annealing furnace slowly cools the glass down to near room temperature in order to avoid stresses in the glass. The speed of the draw rollers defines the thickness of the glass film. After the drawing process the glass is bent from the vertical into a horizontal position for further processing.

After drawing the thin glass has a fire-polished lower and upper surface in its two-dimensional expansion. “Fire-polished” means that the glass surface during solidification of the glass during thermal molding only forms through the boundary surface to the air and is not subsequently altered either mechanically or chemically. The area of the thus produced thin glass has thereby no contact during thermal molding with other solid or liquid materials. Both aforementioned glass drawing methods result in glass surfaces having a root mean square average (RMS) Rq of a maximum of 1 nanometer, for example a maximum of 0.8 nanometer, a maximum of 0.5 nanometer, or in the range of 0.2 to 0.4 nanometer and an average surface roughness Ra of a maximum of 2 nanometers, for example a maximum of 1.5 nanometer, a maximum of 1 nanometer, or 0.5 to 1.5 nanometer, measured over a length of 670 μm. Root mean square average (RMS) is understood to be the square mean value Rq of all distances measured in a specified direction within the reference distance of the actual profile of a geometrically defined line, averaged by the actual profile. Average surface roughness Ra is understood to be the arithmetic mean from the individual surface roughness of five adjacent individual measuring distances.

Located at the edges of the drawn thin glass are process related thickenings, so-called laces on which the glass is pulled from the draw tank and guided. In order to be able to wind and bend a thin glass in the embodiment of a glass film in a volume-saving manner and also to a small diameter, it is advantageous or necessary to detach these laces.

The method according to the present invention is suitable for this, since it guarantees a smooth and micro-crack free cut edge surface. According to the present invention the method can operate continuously. Consequently it can be utilized as a continuous operation and continuous online-process at the end of the manufacturing process in order to cut off the laces. The separation method is hereby conducted such that only small bulge formations and surface irregularities occur. The thickening of the edges caused by cutting is for example, less than 25% of the glass thickness, less than 10% of the glass thickness, or less than 5% of the glass thickness. It is, for example, suitable if thickening of the edge caused by cutting is less than 25 μm or less than 10 μm.

In one embodiment of the present invention the separation of the thin glass along a predefined cutting line is integrated into the production process of the thin glass such that the thermal energy for the provision of an optimum operating temperature of the cutting line originates completely or partially from the residual heat from the forming process of the glass. This has the advantage of energy savings in the production process, but also a reduction in the introduction of thermal stresses in conjunction with the inventive method.

The thin glass or glass film can also be cut into smaller segments or sizes in a downstream process. After its production a glass film is also wound into a roll and is subsequently unwound from the roll for further processing. Further processing can include reworking of the edge (for example in a roll-to-roll operation) or cutting to size of the thin glass. The method according to the present invention is suitable also for this since it can be utilized in a continuous operation for cutting smaller segments and sizes from the continuous ribbon coming off the glass roll and ensures a smooth and micro-crack free cut edge surface.

In principle the same processing speeds can be used here as when using the online-process directly after shaping. However, in order to optimize the cut edge surface characteristics, a lower processing speed can also be selected in coordination with other method parameters such as significantly the laser wave length, laser output and the operating temperature. Optimum is hereby a cut edge without thickening, meaning that the thickness of the cut edge is consistent with the thickness of the thin glass, as well as an exceedingly smooth, micro-crack free surface.

The method according to the present invention can also be utilized as a discontinuous process in order to cut thin glasses, for example from flat-stored thin glass stock sizes or to clean existing edges.

If the operating temperature of the cutting line is not sufficiently high from the residual heat from an upstream process, for example a shaping process, then according to the present invention the predefined cutting line of the thin glass is heated to an operating temperature prior to actual separation. The operating temperature is the temperature which exists in the region of the cutting line that is subsequently separated using of laser energy input. In a first embodiment of the present invention the operating temperature is, for example, at a temperature greater than 250 K (Kelvin) below the transformation point Tg of the glass of the thin glass sheet, or even greater than100 K below Tg. In an alternative embodiment, the temperature is, for example in a range of 50 K above and below Tg, or in a range of 30 K above and below Tg. The transformation point (Tg) is thereby the temperature at which the glass transitions during cooling from the viscous state to the solid state.

In principle the laser radiation couples more easily into a hotter glass. If however the viscosity of the glass becomes too low, then the surface tension acts in the direction of the formation of a thickening at the cut edge which should be avoided if at all possible, or should be kept to a minimum.

According to the present invention the operating temperature is selected in coordination with the remaining parameters in such a way, that a very smooth, micro-crack free cut edge surface without thickening is created. An edge thickening should, for example, be no more than 25% of the glass thickness, for example no more thanl5%, or no more than 5% of the glass thickness.

In one embodiment of the present invention only the region around the cutting line is heated with the assistance of a heat source, for example a burner or a radiant heater. The energy input occurs, for example using a gas flame. The flame should burn as soot-free as possible. Basically all flammable gases, such as for example methane, ethane, propane, butane, ethane or natural gas are suitable for this. One or several burners may be selected for this purpose. Burners having different flame configurations can be utilized. Especially suitable are line burners or individual lance burners.

In one embodiment of the present invention the entire width of the thin glass in the region of separation along the cutting line, perpendicular to the feed direction of the glass or perpendicular to the feed direction of the laser for cutting the glass, is heated to an operating temperature. In the embodiment of a continuous process the thin glass is hereby moved through a furnace with an appropriate speed which is coordinated with the heating and cutting process. In the furnace the thin glass is heated with the assistance of burners or an infrared radiation source or with the assistance of heating rods as a heat radiation source. With suitable construction and insulation in the furnace, as well as targeted temperature guidance a uniform and controlled temperature profile can be set in the thin glass, which has a particularly favorable effect on the stress distribution in the thin glass. Alternatively, a thin glass sheet can be brought into a furnace in a discontinuous method and can be uniformly heated.

Actual separation of the thin glass occurs according to the present invention through energy input along the cutting line using a laser beam which has the effect that a separation of the thin glass sheet occurs and a continuous cut edge is created. Hereby the glass is not broken as is the case with the laser scribe method, but instead is virtually melted-through in a very narrow region. A CO₂ laser, for example a CO₂ laser having a wavelength in the range of 9.2 to 11.4 μm, of 10.6 μm, or a CO₂ laser having double frequency is suitable for this. This may be a pulsed CO₂ laser or a continuous wave CO₂ laser (cw-laser).

For implementation of the inventive method a median laser output P_{AV} of less than 500 Watts (W), for example less than 300 W, or less than 200 W is suitable, for example with a view to the cutting speed when a CO₂ laser is used. With regard to the cut edge quality a medium laser output of less than 100 W is feasible which is necessary for the creation of a good cut edge quality, whereby however the cutting speed is low.

For implementation of the inventive method a median laser pulse frequency fᵣₑₚ of 5 to 12 kHz (kilohertz) is feasible, for example a medium laser pulse frequency fᵣₑₚ of 8 to 10 kHz when a pulsed CO₂ laser is used.

Moreover, a laser pulse duration tₚ of 0.1 to 500 μs (micro seconds) is feasible for a laser pulse duration tₚ of 1 to 100 μs when a pulsed CO₂ laser is used.

The input of energy to separate the thin glass along the cutting line according to the present invention can occur with any suitable laser. In addition to a CO₂ laser a yttrium-aluminum-garnet (YAG) laser may be utilized, such as a Nd:YAG laser (neodymium-doped yttrium-aluminum-garnet solid state laser) having a wave length range of 1047 to 1079 nm (nanometer), for example of 1064 nm. Moreover, a Yb:YAG laser (yttrium-doped yttrium-aluminum-garnet solid state laser) can be used having a wavelength in the range of 1030 nm. Both types of laser can also be utilized with frequency doubling or frequency tripling.

According to the present invention YAG-lasers are used for separating the thin glass, for example a glass film in particular with a high pulse frequency in the Pico- and nanosecond range by creating laser ablating at an operating temperature along a predefined cutting line. The cut edge surface is also very smooth, however compared to separating the glass with a CO₂ laser, displays greater rippling. The cut edge is also free of micro-cracks and displays a low dispersion of the strength values in the 2-point bending test.

Furthermore, an excimer-laser, such as an F₂-laser (157 nm), ArF-laser (183 nm), KrF-laser (248 nm) or an Ar-laser (351 nm) can also be used. Such laser types can—depending on the embodiment of the present invention—be operated as pulsed or continuous (continuous wave) lasers.

According to the present invention the input of energy for the purpose of separating the thin glass, such as a glass film along the cutting line occurs at a processing speed v_{f} of 2 to 110 m/min., for example 10 to 80 m/min., or preferably 15 to 60 m/min. When utilizing the method in the online-process the processing speed is in direct relation with the shaping of the thin glass, depending on the glass ribbon speed during production and on the glass thickness. In correlation with the glass volume, thinner glass is drawn faster than thicker glass. The processing speed, for example for a thin glass of 100 μm thickness, is thus at 8 m/min., for a thin glass of 15 μm at 55 m/min. When using the method in conjunction with cutting the thin glass in roll-to-roll operation or from a flat stock, processing speeds of 15 to 60 m/min can be used. The processing speed is understood to be the feed speed of the separation cut along the cutting line. The thin glass can hereby be guided along a stationary laser or the laser can move along a stationary thin glass, or both move relative to each other.

The laser can hereby describe a continuous feed motion along a predefined cutting line, or the laser can move forward, scanning back and forth once or several times along the cutting line.

In one embodiment wherein heating of the thin glass occurs in a furnace, the laser beam is introduced into the furnace through an opening or through a window in the cover of the furnace which is transparent for the laser wavelength. This protects the laser from the damaging influence of the operating temperature and ensures that the temperature distribution of the thin glass is not influenced in the region of the cutting line or influenced only to a small extent and that a reliable control of the operating temperature is ensured.

After separation one cut edge can have a fire-polished surface without however thickening this edge due to surface tension acting upon the entire edge. For this it is important that the surface of the cut edge becomes molten only to a very limited depth or that only small areas of the surface melt. If the surface area at the cut edge becomes too soft the edge will contract and form a thickening which, the more it is defined represents a greater impairment when using the thin glass or also when rolling it up as glass film.

In particular, such a cut edge has an average surface roughness Ra of a maximum of 2 nanometers, such as a maximum of 1.5 nanometer, or a maximum of 1 nanometer and a root mean square average (RMS) Rq of a maximum of 1 nanometer, such as a maximum of 0.8 nanometer, or a maximum of 0.5 nanometer.

In an additional embodiment of the present invention the thin glass is relaxed in a furnace, for example a continuous furnace from thermally induced stresses which occurred during the separating procedure. It is possible that in one further embodiment of the invention stresses occur due to heat input into the thin glass. These stresses can lead to distortion of the thin glass, in particular the glass film or can become the reason for the risk of breakage when bending or winding the glass. In this case the glass is relaxed in an annealing furnace. The glass film is thereby heated, for example in an online process, with a predefined temperature profile and undergoes targeted cooling. Heating can occur hereby in conjunction with provision of the operating temperature for cutting. Also, in order to avoid that stresses occur in the glass during cooling after the inventive separation, it is subjected to a targeted cooling, for example in an annealing furnace.

An example is explained by the present invention as follows:

A glass film having a thickness of 50 μm, as offered by Schott AG, Mainz under reference AF32®eco was heated in a furnace. On both sides of the glass film the edge was separated with a width of 25 mm. The alkaline-free glass had the following composition in weight-%.

| | |
|---|---|
| SiO₂ | 61 |
| Al₂O₃ | 18 |
| B₂O₃ | 10 |
| CaO | 5 |
| BaO | 3 |
| MgO | 3 |

The transformation temperature Tg of the glass is 717° C. Its density is 2.43 grams per cubic centimeter (g/cm³). The root mean square average Rq of the top and underside of the glass film is between 0.4 and 0.5 nm. The surface is therefore extremely smooth.

At its upper cover the furnace was equipped at two locations with a slotted hole through which respectively a laser beam was focused respectively onto a point along the two cutting lines. Each slotted hole extended parallel to the edges of the glass film below, so that the edges could be separated accordingly. The furnace was a continuous furnace through which the glass film was moved at a feed speed of 25 m/min. Heating of the furnace was electric, so that the operating temperature of each of the two cutting lines was 737+ or −5° C.

A pulsed CO₂ laser having a wave length of 10.6 μm was used in each case as the energy source. The energy was input with a laser power of 200 Watts (W), a laser pulse frequency of 9 kHz and a laser pulse duration of 56 μs. In the course of the operating progression a single back and forth movement of the laser beam along the cutting line occurred each time, so that each point on the cutting line was supplied twice with laser energy. The glass was subsequently completely separated. The cut edges were completely fire-polished and had an averaged surface roughness Ra of 0.3 to 0.4 nm (line measurement 670 μm). The edge thickness was an average of 60 μm, so that with a thickening of 10 μm an average thickening of the edges of 20% occurred which is far below the thickening of 25 μm when cutting according to International Patent No. DE 196 16 327.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for separating a thin glass sheet along a predefined cutting line, the method comprising the step of inputting energy along said predefined cutting line using a laser beam to separate the thin glass sheet along said predefined cutting line, wherein the cutting line immediately prior to separation has an operating temperature of greater than 250 Kelvin (K) below a transformation point (T_{g}) of a glass forming the thin glass sheet, including said input energy along said predefined cutting line from said laser beam.

2. The method according to claim 1, wherein the thin glass sheet is a glass film having a thickness of a maximum of approximately 250 micrometers (μm).

3. The method according to claim 2, wherein said thickness of the glass film is at least 5 μm.

4. The method according to claim 2, wherein the glass film is formed from a glass having an alkaline oxide content of a maximum of approximately 2 weight percent (%).

5. The method according to claim 2, wherein the glass film includes (in weight % on an oxide basis):

| | |
|---|---|
| SiO₂ | 40-75; |
| Al₂O₃ | 1-25; |
| B₂O₃ | 0-16; |
| Alkaline earth oxide | 0-30; and |
| Alkaline oxide | 0-2. |

6. The method according to claim 2, wherein the glass film includes (in weight % on an oxide basis):

| | |
|---|---|
| SiO₂ | 40-75; |
| Al₂O₃ | 5-25; |
| B₂O₃ | 1-16; |
| Alkaline earth oxide | 1-30; and |
| Alkaline oxide | 0-1. |

7. The method according to claim 1, further comprising the step of heating an entire width of the thin glass sheet in a region of said separation along the cutting line to said operating temperature, said region being perpendicular to a feed direction of the thin glass sheet or said laser.

8. The method according to claim 1, wherein said energy input along said predefined cutting line is from a CO₂ laser.

9. The method according to claim 8, wherein said CO₂ laser is one of a pulsed CO₂ and a continuous CO₂ laser having a median laser output (P_{AV}) of less than 500 Watts (W).

10. The method according to claim 8, wherein said CO₂ laser is a pulsed CO₂ laser having a median laser pulse frequency (fᵣₑₚ) in a range of between approximately 5 and 12 kilohertz (kHtz).

11. The method according to claim 8, wherein said CO₂ laser is a pulsed CO₂ laser having a laser pulse duration (tₚ) in a range of between 0.1 and 500 microseconds (μs).

12. The method according to claim 1, wherein said laser beam for said input of energy is from an yttrium-aluminum-garnet (YAG) laser.

13. The method according to claim 1, wherein said laser beam for said input of energy is from an excimer laser.

14. The method according to claim 1, wherein said input of energy along said predefined cutting line occurs at a processing speed (v_{f}) in a range of between 2 and 110 meters per minute (m/min).

15. The method according to claim 7, wherein said heating step occurs in a furnace and said energy input from said laser beam is from a laser through one of an opening and a window in a cover of said furnace, said cover being transparent for a laser wavelength of said laser beam.

16. The method according to claim 1, further comprising the step of coordinating said laser wavelength, said laser output, said operating temperature and said processing speed with each other to form a cut edge having a fire-polished surface after said separation.

17. The method according to claim 1, further comprising the step of coordinating said laser wavelength, said laser output, said operating temperature and said processing speed with each other such that said cut edge over a measuring length of approximately 670 μm after said separation has an average surface roughness (Ra) of a maximum of 2 nanometers (nm).

18. The method according to claim 1, further comprising the step of coordinating said laser wavelength, said laser output, said operating temperature and said processing speed with each such that said cut edge over said measuring length of approximately 670 μm after said separation has a root mean square average (Rq) of a maximum of approximately 1 nm.

19. The method according to claim 1, further comprising the step of producing the thin glass sheet in one of a down-draw method and an overflow-downdraw-fusion method, said producing step and said separation being a continuous process.

20. The method according to claim 1, further comprising the step of unrolling the thin glass sheet from a glass roll prior to said separation, said unrolling step and said separation being in a continuous process.

21. The method according to claim 1, further comprising the step of relaxing the thin glass sheet in a furnace from a plurality of thermally induced stresses from said separation.

22. The method according to claim 1, wherein a thickening of said cut edge caused by said separation is less than approximately 25%.

23. The method according to claim 22, wherein said thickening of said cutting edge is less than 25 μm.
